(19) United States
(12) Patent Application Publication
(10) Pub. No.: US 2022/0396004 A1
(43) Pub. Date: Dec. 15, 2022

(54) Z-AXIS INTEGRATED WITH STORAGE, COMMIXTURE AND EXTRUSION OF MATERIALS AND 3D BUILDING PRINTER THEREOF

(71) Applicant: BUILDERA CONSTRUCTION TECH (SHANGHAI) CO., LTD., Shanghai (CN)

(72) Inventors: Xufeng JIANG, Shanghai (CN); Junguo LI, Shanghai (CN)

(21) Appl. No.: 17/617,023

(22) PCT Filed: Apr. 5, 2021
(86) PCT No.: PCT/CN2021/085507

§ 371 Date: Dec. 7, 2021

(30) Foreign Application Priority Data
Dec. 25, 2020 (CN) 202011564937.3

(51) Int. Cl. B28B 1/00; E04G 21/04; B33Y 30/00

(52) U.S. Cl. CPC B28B 1/001; E04G 21/04; B33Y 30/00

(57) ABSTRACT

A Z-axis that is integrated with storage, commixture and extrusion of materials, including a vertically-moving bucket, and a vertically-moving unit connected to the vertically-moving bucket. The vertically-moving unit can drive the vertically-moving bucket to move vertically. The vertically-moving bucket is used to store printing materials. A printing nozzle connected to the vertically-moving bucket is provided at the bottom of the vertically-moving bucket, which is connected with the printing nozzle through a stirring unit. The vertically-moving bucket replaces the existing vertically-moving axis, so that the printing nozzle can directly communicate with the vertically-moving bucket without pipelines to connect the printing nozzle to the vertically-moving bucket. Also, a 3D building printer that does not need to erect a relaying bucket in the sky, which solves the problem of pipeline blockage and cleaning.

### TECHNICAL FIELD

The invention relates to the technical field of construction, in particular to a Z-axis integrated with storage, commixture and extrusion of materials and a 3D building printer thereof.

### BACKGROUND ART

When printing buildings, a 3D building printer needs to deliver printing materials such as concrete and wet-mixed mortar to a printing nozzle, but the printing nozzle is required to continuously operate in the sun or even at a high temperature with the hot sun, and in the case of passing coarse aggregates or containing fibers, the pipe commonly used to deliver the printing materials is easily blocked. Moreover, conveying pipelines for mixing and pumping will need to be cleaned frequently at the end of a day's work due to the expansion of the working site for printing buildings and the lengthened distance for the building materials from pumped to discharged out of a nozzle, which will be wasted in large quantities day after day. Although it is possible to erect a relaying bucket in the sky, a pipeline is still required to deliver printing materials between the relaying bucket and the printing nozzle, which cannot completely overcome the problems of pipeline blockage and cleaning.

### SUMMARY OF THE INVENTION

The objective of the invention is to overcome the defects of the prior art and provide a Z-axis integrated with storage, commixture and extrusion of materials.

In order to achieve the above objectives, the present invention adopts the following technical solutions:

A Z-axis integrated with storage, commixture and extrusion of materials, comprising: a vertically-moving bucket, and a vertically-moving unit connected to the vertically-moving bucket, wherein the vertically-moving unit can drive the vertically-moving bucket to move vertically, the vertically-moving bucket is used to store printing materials, a printing nozzle connected to the vertically-moving bucket is provided at the bottom of the vertically-moving bucket, which is connected with the printing nozzle through a stirring unit mixing printing materials with water.

Preferably, the vertically-moving bucket is provided with a controlling bucket, in which a preliminarily-stirring motor, a dust removal cloth bag and a material-level meter are arranged, a dry powder inlet is provided on the vertically-moving bucket, a preliminary stirrer connected to the preliminarily-stirring motor is provided inside the vertically-moving bucket, and can be driven by the preliminarily-stirring motor to rotate.

Preferably, a rack is provided on the side of the vertically-moving bucket, the vertically-moving unit includes a gear meshing with the rack.

Preferably, a screw stem is provided on the side of the vertically-moving bucket, the vertically-moving unit includes a nut meshing with the screw stem.

Preferably, the Z-axis includes at least 2 stirring units, the at least 2 stirring units are connected between them through a screw pump.

Preferably, a stirrer is provided inside the vertically-moving bucket.

Preferably, the vertically-moving bucket is connected with the printing nozzle through 3 stirring units, which are a 1-stage stirring unit, a 2-stage stirring unit, and a 3-stage stirring unit, respectively, and each of which consists of one stirring chamber and the stirrer arranged inside the stirring chamber, and the stirring chambers of the 3 stirring units are connected to the next in sequence, and the stirring chamber inside the 3-stage stirring unit communicates with the printing nozzle.

Preferably, the stirring chamber of the 1-stage stirring unit communicates with the bottom of the vertically-moving bucket, one end of the stirrer of the 1-stage stirring unit is positioned inside the stirring chamber of the 1-stage stirring unit, while another end is positioned at the bottom of the vertically-moving bucket, a water inlet is provided on the 1-stage stirring unit, which mixes dry mortar in the vertically-moving bucket with water into wet-mixed mortar, and then the wet-mixed mortar passes through the 2-stage stirring unit and the 3-stage stirring unit in sequence, and is finally extruded from the printing nozzle.

Preferably, a second material-level meter is arranged inside the 2-stage stirring unit, the second material-level meter has the ability to turn off the 1-stage stirring unit.

Preferably, the stirrer of the 3-stage stirring unit includes 2 cross-shaped stirring members arranged coaxially, the 2 stirring members include 4 stirring blades, respectively, and the stirring blades of the 2 stirring members are staggered in the axial direction.

Preferably, the 1-stage stirring unit includes al-stage stirring chamber and a 1-stage stirrer arranged in the 1-stage stirring chamber, the 2-stage stirring unit includes a 2-stage stirring chamber and a 2-stage stirrer arranged in the 2-stage stirring chamber, the 3-stage stirring unit includes a 3-stage stirring chamber and a 3-stage stirrer arranged in the 3-stage stirring chamber, the 2-stage stirring unit is connected with the 3-stage stirring unit by a screw pump, which includes a pump chamber and the rotor arranged inside the pump chamber, the vertically-moving bucket, the 1-stage stirring chamber, the 2-stage stirring chamber, the pump chamber and the 3-stage stirring chamber communicate with the next in sequence.

Preferably, the 1-stage stirring chamber and the 2-stage stirring chamber are perpendicularly arranged, the 2-stage stirring chamber, the pump chamber and the 3-stage stirring chamber are parallelly arranged, a 2-stage stirring motor is arranged outside the 2-stage stirring chamber, the output shaft of the 2-stage stirring motor, the 2-stage stirrer inside the 2-stage stirring chamber, the rotor inside the pump chamber and the 3-stage stirrer inside the 3-stage stirring chamber are arranged coaxially.

Preferably, the 1-stage stirring chamber, the 2-stage stirring chamber, the pump chamber and the 3-stage stirring chamber are parallelly arranged, a 1-stage stirring motor is arranged outside the 1-stage stirring chamber, the output shaft of the 1-stage stirring motor, the 1-stage stirrer inside the 1-stage stirring chamber, the 2-stage stirrer inside the 2-stage stirring chamber, the rotor inside the pump chamber and the 3-stage stirrer inside the 3-stage stirring chamber are arranged coaxially.

In the Z-axis integrated with storage, commixture and extrusion of materials according to the invention, the vertically-moving bucket replaces the existing vertically-moving axis, so that the printing nozzle can directly communicate with the vertically-moving bucket, and the Z-axis concurrently performs the functions as storage, commixture and extrusion, with a small volume and little or no need to connect the printing nozzle to the vertically-moving bucket.

The present invention also provides a 3D building printer, comprising a horizontal movement platform and the Z-axis integrated with storage, commixture and extrusion of materials provided on the horizontal movement platform.

Preferably, a guiding rail is arranged on the side of the vertically-moving bucket, the horizontal movement platform is provided with a sliding block slidably coordinating with the guiding rail, which is limited by the sliding block to move in the vertical direction after passing through the sliding block.

Preferably, the horizontal movement platform includes two spaced crossbeams, between which an avoidance space for avoiding the vertically-moving bucket is formed, the horizontal movement platform includes a Y-axis movement platform movably arranged on the two crossbeams, and a Y-axis movement mechanism used to drive the Y-axis movement platform to move, the Y-axis movement platform is provided with an avoidance channel corresponding to the avoidance space, the vertically-moving bucket can pass through the avoidance channel.

Preferably, the Y-axis movement platform is provided with a guiding roller and a limiting roller, the limiting roller is connected to the Y-axis movement platform through a suspension support, the guiding roller and the limiting roller match with the upper and lower sides of the crossbeam.

The 3D building printer provided by the invention does not need to erect a relaying bucket in the sky, and the printing nozzle is not required to be directly connected with a pipeline to deliver printing materials, which solves the problem of pipeline blockage and cleaning.

### BRIEF DESCRIPTION OF THE DRAWINGS

FIG. 1 is a schematic diagram of the 3D building printer according to the example of the invention.

FIG. 2 is a partial enlarged view of FIG. 1 of the example of the invention.

FIG. 3 is a front view of the 3D building printer according to the example of the invention.

FIG. 4 is a partial enlarged view of FIG. 3 of the example of the invention.

FIG. 5 is a top view of the 3D building printer according to the example of the invention.

FIG. 6 is a partial enlarged view of FIG. 5 of the example of the invention.

FIG. 7 is a side view of the 3D building printer according to the example of the invention.

FIG. 8 is a front view of a vertically-moving bucket according to the first example of the invention.

FIG. 9 is a side view of a vertically-moving bucket according to the first example of the invention.

FIG. 10 is a top view of a vertically-moving bucket according to the first example of the invention.

FIG. 11 is an A-A cross-sectional view of FIG. 10 of the example of the invention.

FIG. 12 is an D-D cross-sectional view of FIG. 9 of the example of the invention.

FIG. 13 is a front view of a vertically-moving bucket according to the second example of the invention.

FIG. 14 is a side view of a vertically-moving bucket according to the second example of the invention.

FIG. 15 is a top view of a vertically-moving bucket according to the second example of the invention.

FIG. 16 is an A-A cross-sectional view of FIG. 15 of the example of the invention.

FIG. 17 is a schematic diagram of the 3-stage stirrer according to the example of the invention.

FIG. 18 is a schematic diagram of the mortise-tenon connection of the example of the invention.

FIG. 19 is another example of the Y-axis movement platform of the invention.

FIG. 20 is an A-A cross-sectional view of FIG. 19 of the invention.

### DETAILED DESCRIPTIONS OF THE PREFERRED EMBODIMENTS

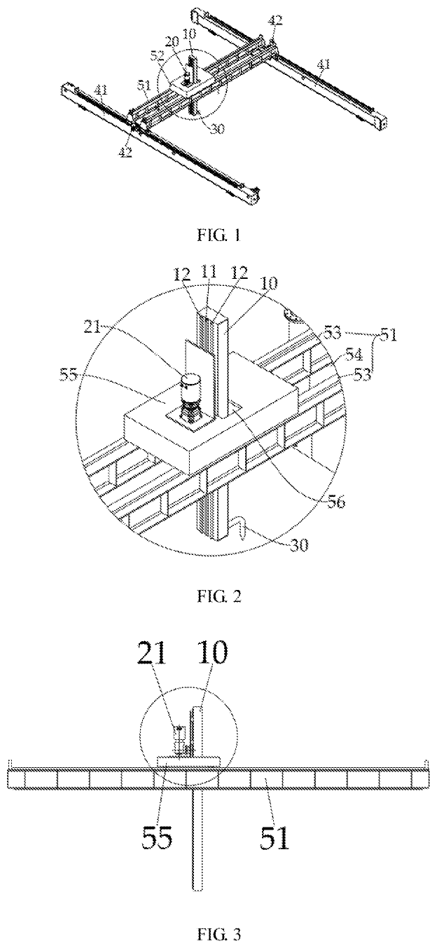

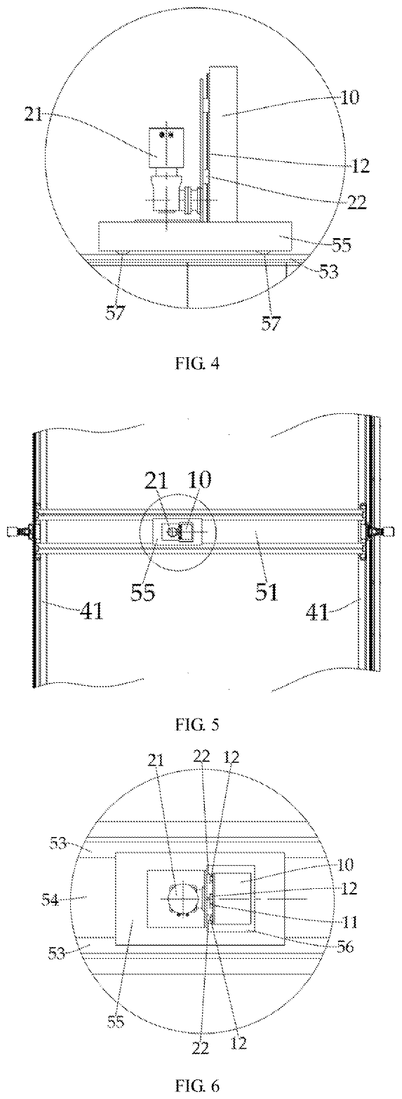

As shown in FIGS. 1-6, the Z-axis integrated with storage, commixture and extrusion of materials according to the invention includes the vertically-moving bucket 10, and the vertically-moving unit 20 connected to the vertically-moving bucket 10. The vertically-moving bucket 10 is used to store printing materials. The vertically-moving unit 20 can drive the vertically-moving bucket 10 to move vertically. The printing nozzle 30 connected to the vertically-moving bucket 10 is provided at the bottom of the vertically-moving bucket 10 (FIG. 6).

The Z-axis integrated with storage, commixture and extrusion of materials according to the invention has the vertically-moving bucket 10 replacing the existing vertically-moving axis, so that the printing nozzle 30 can directly communicate with the vertically-moving bucket 10 without pipelines to connect the printing nozzle 30 with the vertically-moving bucket 10.

In addition, the horizontal movement platform limits the volume of the existing relaying bucket installed on it, and the vertically-moving bucket 10 according to the invention can move vertically, so its volume can be designed to be larger with a possibility of storing more materials and the ability to operate more durably and stably.

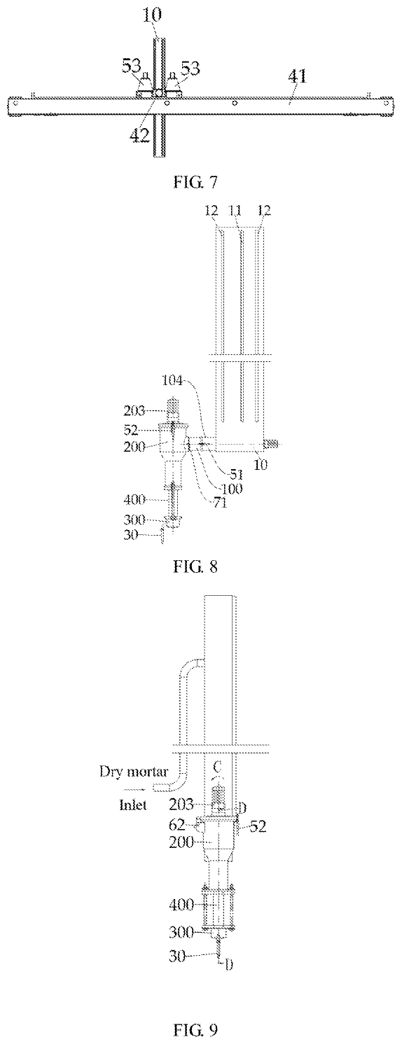

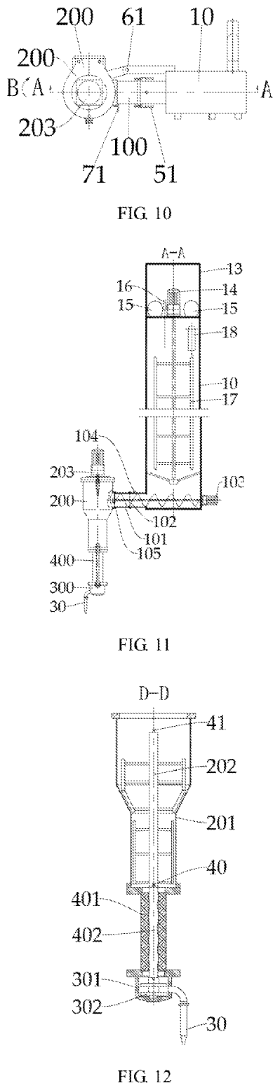

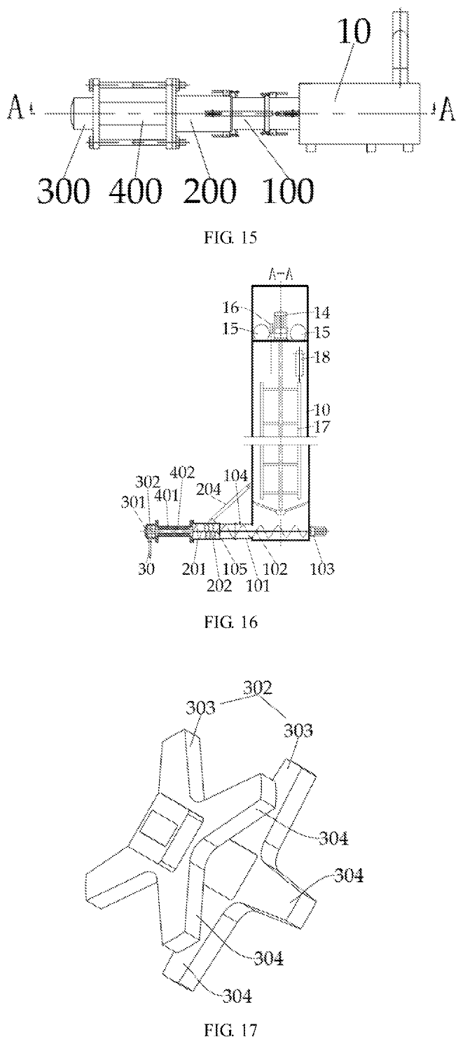

The specific example of the 3D building printer according to the invention will be further described below in combination with the examples given in FIGS. 1-20. The 3D building printer according to the invention is not limited to the description of the following examples.

As shown in FIGS. 1-6, the Z-axis integrated with storage, commixture and extrusion of materials according to the invention includes the vertically-moving bucket 10, and the vertically-moving unit 20 connected to the vertically-moving bucket 10. The vertically-moving bucket 10 is used to store printing materials. The vertically-moving unit 20 can drive the vertically-moving bucket 10 to move vertically. The printing nozzle 30 connected to the vertically-moving bucket 10 is provided at the bottom of the vertically-moving bucket 10 (FIG. 6).

As shown in FIGS. 1-7, the invention also provides a 3D building printer, which includes a horizontal movement platform. The Z-axis integrated with storage, commixture and extrusion of materials is arranged on the horizontal movement platform, which can drive the vertically-moving bucket 10 to move horizontally.

The horizontal movement platform in this example includes the X-axis rail 41 and the Y-axis rail 51 perpendicular to each other. The X-axis rail 41, the Y-axis rail 51, and the vertically-moving bucket 10 are arranged parallel to the X-axis, Y-axis and Z-axis of the rectangular coordinate system, respectively. The Y-axis rail 51 moves in the X-axis direction on the X-axis rail 41, while the vertically-moving bucket 10 moves in the Y-axis direction on the Y-axis rail 51, and the vertically-moving unit 20 drives the vertically-moving bucket 10 to move in the Z-axis direction, so that the vertically-moving bucket 10 can move in three directions of the X-axis, the Y-axis and the Z-axis. During movement, the printing nozzle 30 extrudes printing materials such as concrete and wet-mixed mortar, stacking them layer by layer to finally form a building.

Specifically, the horizontal movement platform in this example includes two X-axis rails 41 parallelly arranged, and the Y-axis rail 51 connected between the two X-axis rails 41. The X-axis movement unit 42 is installed on each of the two X-axis rails 41, and both ends of the Y-axis rail 51 are connected to the X-axis movement units 42 on the two X-axis rails 41, respectively. The X-axis movement unit 42 in this example is a right-angle geared motor, and at least one X-axis movement unit 42 can drive the Y-axis rail 51 to move in the length direction of the X-axis rail 41. The Y-axis rail 51 is provided with the Y-axis movement unit 52, on which the vertically-moving bucket 10 is installed. The Y-axis movement unit 52 can drive the vertically-moving bucket 10 to move in the length direction of the Y-axis rail 51, while the vertically-moving unit 20 drives the vertically-moving bucket 10 to move vertically, which finally enables the vertically-moving bucket 10 and the printing nozzle 30 to move in the length direction of the X-axis rail 41, the length direction of the Y-axis rail 51 and the vertical direction. The vertical direction in this example is equivalent to the existing length direction of the Z-axis rail concurrently perpendicular to the X-axis rail 41 and the Y-axis rail 51.

The two X-axis rails 4 of the mobile platform in this example 1 have a more reliable gantry structure, which provides stable support to the Y-axis rail 51 and the vertically-moving bucket 10. If the vertically-moving bucket 10 contains a great quantity of materials, it can still move stably.

The X-axis movement unit 42 in this example is composed of the gear 23 and the motor connected to the gear 23, and the rack 11 meshing with the gear 23 is provided on the X-axis rail 41. When the motor drives the gear 23 to rotate, the rack 11 pushes the X-axis movement unit 42 to move. The Y-axis movement unit 52 can also adopt the same principle as the X-axis movement unit 42.

It is obvious that the X-axis rail 41 and the Y-axis rail 51 can also be interchanged with each other, that is, the X-axis rail 41 is arranged on the Y-axis rail 51, so that the X-axis rail 41 moves in the length direction of the Y-axis rail 51, and the vertically-moving bucket 10 is arranged on the X-axis rail 41 and moves in the length direction of the X-axis rail 41.

In addition, the number of the Y-axis rails 51 can also be more than one, and the vertically-moving bucket 10 is provided on a plurality of the Y-axis rails 51, respectively, and a plurality of the vertically-moving buckets 10 can operate concurrently, especially with a large capacity for each of the vertically-moving buckets 10.

As shown in FIGS. 2 and 6, the Y-axis rail 51 includes two spaced crossbeams 53, on which the vertically-moving bucket 10 moves, and between which the avoidance space 54 for avoiding the vertically-moving bucket 10 is formed, and the Y-axis movement unit 52 can drive the vertically-moving bucket 10 to move along the avoidance space 54.

Specifically, the two ends of the two crossbeams 53 are connected to the same X-axis movement unit 42, respectively. The Y-axis movement unit 52 is a moving trolley, and the Y-axis movement unit 52 includes the Y-axis movement platform 55 and 2 columns of Y-axis movement mechanisms arranged on both sides of the bottom surface of the Y-axis movement platform 55 and matched with the crossbeam 53 respectively. Each column of the Y-axis movement mechanisms includes two guiding rollers 57 touching the crossbeam 53. The Y-axis movement platform 55 matches with the crossbeam 53 through gears and racks, and moves on the crossbeam 53 in a transfer motion of the gears and racks.

The two sides of the bottom surface of the Y-axis movement platform 55 match with the two crossbeams 53, respectively. The middle of the Y-axis movement platform 55 is provided with the avoidance channel 56 corresponding to the avoidance space 54 between the two crossbeams 53. The vertically-moving bucket 10 can pass through the avoidance channel 56, on one side of which the vertically-moving unit 20 is arranged and connected between the vertically-moving bucket 10 and the Y-axis movement platform 55.

In this example, we separately arranged the two beams 53 to make them spaced and connected to the X-axis rail 41, respectively. This structure not only forms the avoidance space 54 between the two crossbeams 53, enabling the vertically-moving bucket 10 to move in the Y-axis direction without obstruction, but also can provide support to both sides of the bottom surface of the Y-axis movement platform 55, enabling the vertically-moving bucket 10 to ensure stability when storing a great quantity of materials, and preventing the vertically-moving bucket 10 from skewing and shaking during movement.

It is obvious that the Y-axis rail 51 can also be an integral structure, or the Y-axis rail 51 does not form the avoidance space 54, with the vertically-moving bucket 10 being arranged on one side of the Y-axis rail 51, but it is difficult to ensure the balance and stability of the Y-axis movement platform and the vertically-moving bucket 10.

In addition, the avoidance channel 56 for avoiding the vertically-moving bucket 10 is provided on the middle of the Y-axis movement platform 55, so that the vertically-moving bucket 10 can be arranged at the center of the Y-axis movement platform 55 to further ensure its stability. Of course, the Y-axis movement platform 55 can also adopt other shapes, or the vertically-moving bucket 10 is arranged on one side of the Y-axis movement platform 55, all pertaining to the protection scope according to the invention.

As shown in FIGS. 19-20, the Y-axis movement platform 55 is provided with a guiding roller 57 and a limiting roller 58. The limiting roller 58 is connected to the Y-axis movement platform 55 through the suspension support 59 (The limiting roller is replaced by a slider, which can also achieve the function of preventing an overturn, also for the X-axis the same as the Y-axis.). The guiding roller 57 and the limiting roller 58 match with the upper and lower sides of the crossbeam 53, respectively, so as to limit the Y-axis movement platform 55 and the vertically-moving bucket 10 arranged on the Y-axis movement platform 55, preventing the vertically-moving bucket 10 from raising the center of gravity, therefore overturning during movement. It is obvious that the X-axis movement unit 42 used to connect the crossbeam 53 can also be in position-limiting coordination with the upper and lower sides of the X-axis rail 41 in the same way. Further, the vertically-moving unit 20 is arranged on the side of the vertically-moving bucket 10 to match with the vertically-moving bucket 10, the side of which is provided with the rack 11 and the two guiding rails 12 parallelly arranged on both sides of the rack 11, respectively. The vertically-moving unit 20 includes the gear 23 (not shown in the figures) meshing with the rack 11 and the movement unit 21 arranged on the horizontal movement platform to drive the gear 23 to rotate. The movement unit 21 includes the motor and the reducer connected between the motor and the gear 23. The Y-axis movement platform 55 is provided with the sliding block 22 slidably coordinating with the guiding rail 12, which is limited by the sliding block 22 to move in the vertical direction after passing through the sliding block 22. It is obvious that the guiding roller 57 and the limiting roller 58 can also be replaced with a structure similar to the sliding block 22 with a corresponding guide rail 12 arranged on the crossbeam 53 to match with them, all pertaining to the protection scope according to the invention.

Although meshing the rack 11 with and the gear 23 can be suitable for the longer vertically-moving bucket 10 so as to enable the vertically-moving bucket 10 to store more printing materials and have a larger range of movement, but the vertically-moving unit 20 can also drive the vertically-moving bucket 10 to move by means of a screw. For example, a screw stem (not shown in the figures) is provided on the side of the vertically-moving bucket 10, the vertically-moving unit 20 includes the nut threaded with the screw stem. When the nut rotates, the screw stem is pushed along the thread to drive the vertically-moving bucket 10 to move.

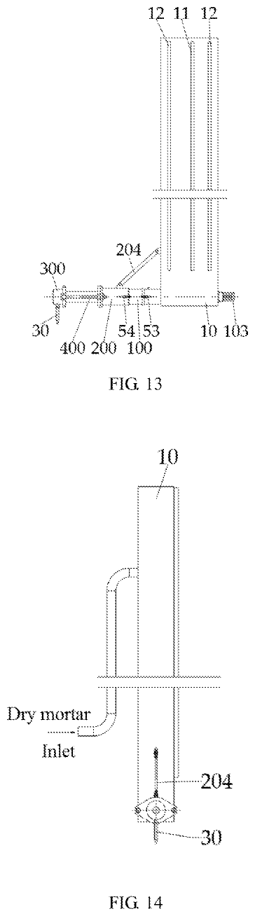

FIGS. 8-12 show the first example of the vertically-moving bucket 10, and FIGS. 13-16 show the second example of the vertically-moving bucket 10. The vertically-moving bucket 10 is in a cubic structure, on one side of which the rack 11 and the guiding rail 12 are arranged. The vertically-moving bucket 10 of both examples has the following characteristics:

Referring to FIGS. 9 and 14, the vertically-moving bucket 10 of both examples is connected to the printing nozzle 30 through a stirring unit, respectively, and printing materials such as dry mortar can be delivered to the vertically-moving bucket 10 by means of pneumatic conveying or the like. The dry mortar is mixed with water through the stirring unit in the vertically-moving bucket 10, and then directly shaped through the printing nozzle 30, only with a need for pipelines to deliver dry materials instead of that for wet materials, which can effectively abate the difficulty of delivering materials and the frequency of cleaning pipelines. There may be one or more stirring units.

It is obvious that due to the relatively large capacity of the vertically-moving bucket 10, even if the vertically-moving bucket 10 is not connected to the printing nozzle 30 through the stirring unit, the mixed wet materials can be delivered through pipelines into the vertically-moving bucket 10, still without a need to deliver materials through pipelines between the vertically-moving bucket 10 and the printing nozzle. In addition, a shower head unit for cleaning is provided on the top of the vertically-moving bucket 10. Or, the stirring unit can usually perform stirring and mixing, even if the printing materials are mixed on the ground, the stirring unit can be arranged there, and the printing materials can be mixed uniformly by the stirring unit to ensure uniformity.

Further, the examples provide 3 stirring units, which are the 1-stage stirring unit 100, the 2-stage stirring unit 200, and the 3-stage stirring unit 300, respectively. The three stirring units consist of one stirring chamber and the stirrer arranged inside the stirring chamber, and the stirring chambers of the 3 stirring units are connected to the next in sequence, and the stirring chamber inside the 3-stage stirring unit 300 communicates with the printing nozzle 30.

The stirring chamber of the 1-stage stirring unit 100 communicates with the bottom of the vertically-moving bucket 10. One end of the stirrer of the 1-stage stirring unit 100 is positioned inside the stirring chamber of the 1-stage stirring unit 100, another end is positioned at the bottom of the vertically-moving bucket 10. The stirrer of the 1-stage stirring unit 100 can deliver the dry mortar at the bottom of the vertically-moving bucket 10 into the stirring chamber of the 1-stage stirring unit 100 while stirring.

The 1-stage stirring unit 100 provided with the water inlet 104 mixes the dry mortar in the vertically-moving bucket 10 with water into wet-mixed mortar, and then the wet-mixed mortar passes through the 2-stage stirring unit 200 and the 3-stage stirring unit 300 in sequence, and is finally extruded from the printing nozzle 30, while the dry mortar is more fully and uniformly stirred by three stages, which can greatly improve the quality of printing.

As shown in FIGS. 12 and 16, the 2-stage stirring unit 200 is connected with the 3-stage stirring unit 300 by the screw pump 400, which includes the pump chamber 401 and the wave-shaped rotor 402 arranged in the pump chamber 401.

The 1-stage stirring unit 100 performs the functions as adding water into the dry powder and initially stirring them. The motor of the 1-stage stirring unit 100 rotates at a relatively high speed, so as to fully mix the dry materials.

The 2-stage stirring unit 200 performs the functions as: receiving the materials after stirred by the 1-stage stirring unit 100 that fall into in its V-shaped barrel under the function of gravity; ensuring to fully mix the materials again by stirring the materials at a lower speed than the speed of the 1-stage stirring unit 100; allowing some special functional additives to be added; making the materials enter the screw pump 400 after being stirred by the 2-stage stirring unit 200 and pass through the stator rotor 402 so as to extrude them from the printing nozzle 30.

The 3-stage stirring unit 300 performs the functions as: making the medium more uniform and more continuously and uniformly extruding the materials by dynamically stirring through the mortise-tenon connection of the rotor 402 of the screw pump 400.

It is obvious that a stirrer may also be provided in the vertically-moving bucket 10 to function as the 1-stage stirring unit 100, the 2-stage stirring unit 200, and the 3-stage stirring unit 300, and the stirrer in the vertically-moving bucket 10 can certainly be used to mix the dry powder, all pertaining to the protection scope according to the invention.

Further, the vertically-moving bucket 10 is provided with the controlling bucket 13, in which the preliminarily-stirring motor 14, the dust removal cloth bag 15 and the material-level meter 16 are arranged. The dry powder inlet 18 is provided on the vertically-moving bucket 10, while the preliminary stirrer 17 connected to the preliminarily-stirring motor 14 is provided inside the vertically-moving bucket 10, and can be driven by the preliminarily-stirring motor 14 to rotate. Specifically, the controlling bucket 13 is arranged on the top of the vertically-moving bucket 10, and the preliminarily-stirring motor 14, the dust removal cloth bag 15 and the material-level meter 16 are installed inside the controlling bucket 13. The preliminary stirrer 17 connected to the preliminarily-stirring motor 14 is installed in the middle of the vertically-moving bucket 10, and the dry powder inlet 18 is installed between the upper part of the preliminary stirrer 17 and the controlling bucket 13. The preliminarily-stirring motor 14 can drive the preliminary stirrer 17 to rotate, and the dry mortar will fall freely after entering the vertically-moving bucket 10 from the dry powder inlet 18, meanwhile being uniformly stirred by the preliminary stirrer 17.

Preferably, a second material-level meter (not shown in the figure) is arranged inside the 2-stage stirring unit 200. The second material-level meter is used to control the 1-stage stirring unit 100, and has the ability to turn off the later. As the motor of the 1-stage stirring unit 100 rotates at a much higher speed than that of the 2-stage stirring unit 200, after the materials of the 1-stage stirring unit 100 enter the 2-stage stirring unit 200, the motor of the 1-stage stirring unit 100 needs to be turned off for the 2-stage stirring unit 200, which can prevent the materials of the 1-stage stirring unit 100 from continuously extruding the materials inside the 2-stage stirring unit 200, so as to avoid excessive pressure to the materials inside the 2-stage stirring unit 200 due to extrusion.

FIG. 17 shows the structure of the stirrer of the 3-stage stirring unit 300, which includes 2 cross-shaped stirring members 303 arranged coaxially. The 2 stirring members 303 include 4 stirring blades 304, respectively, and the stirring blades 304 of the 2 stirring members 303 are staggered in the axial direction. The staggered configuration makes the stirring more uniform.

FIGS. 8-12 show the first example of the vertically-moving bucket 10. The 1-stage stirring unit 100 includes the 1-stage stirring chamber 101 and the 1-stage stirrer 102 arranged in the 1-stage stirring chamber 101. The 2-stage stirring unit 200 includes the 2-stage stirring chamber 201 and the 2-stage stirrer 202 arranged in the 2-stage stirring chamber 201. The 3-stage stirring unit 300 includes the 3-stage stirring chamber 301 and the 3-stage stirrer 302 arranged in the 3-stage stirring chamber 301. The vertically-moving bucket 10, the 1-stage stirring chamber 101, the 2-stage stirring chamber 201, the pump chamber 401 and the 3-stage stirring chamber 301 communicate with the next in sequence, and the 1-stage stirring chamber 101 is connected with the 2-stage stirring chamber 201 by the bearing seat 105 (FIG. 11).

In this example, the 1-stage stirring chamber 101 and the 2-stage stirring chamber 201 are arranged perpendicular to each other, while the pump chamber 401 and the 3-stage stirring chamber 301 are arranged parallel to each other. The 2-stage stirring motor 203 is arranged outside the 2-stage stirring chamber 201. The output shaft of the 2-stage stirring motor 203, the 2-stage stirrer 202 inside the 2-stage stirring chamber 201, the rotor 402 inside the pump chamber 401 and the 3-stage stirrer 303 inside the 3-stage stirring chamber 301 are arranged coaxially, and connected to the next in sequence, that is, the output shaft of the 2-stage stirring motor 203 is connected to one end of the 2-stage stirrer 202 through the mortise-tenon connection 40, another end of the 2-stage stirrer 202 is connected to one end of the rotor 402 through the mortise-tenon connection 40, another end of the rotor 402 is the 3-stage stirrer 303 through the mortise-tenon connection.

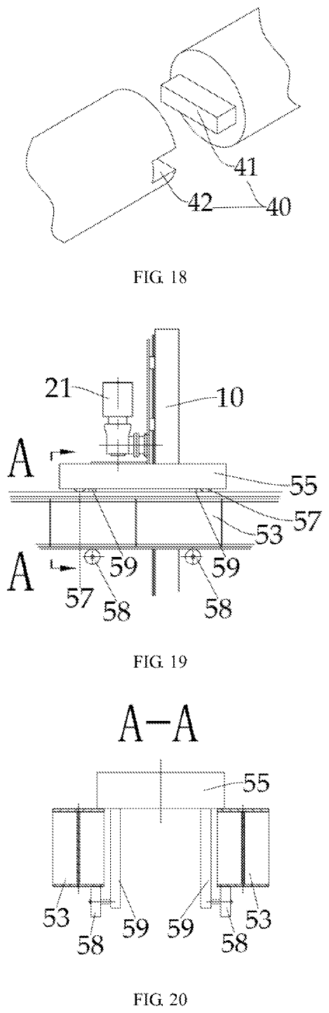

As shown in FIG. 18, the mortise-tenon connection 40 pertains to a prior art. One end of the connection protrudes to form the tenon 41, and another end is dented to form the mortise 42. The tenon 41 is inserted into the mortise 42 to form at least one circumferential limit. One end rotates in the circumferential direction, meanwhile it drives another end to rotate in the circumferential direction, so it is convenient to install and disassemble this connection.

As shown in FIG. 8, the 1-stage stirring chamber 101 of the 1-stage stirring unit 100 is connected with the vertically-moving bucket 10 by the lock catch 51, and the 1-stage stirring chamber 101 can be quickly disconnected from the vertically-moving bucket 10 by removing the lock catch 51.

As shown in FIGS. 8-10, one end of the 2-stage stirring chamber 201 of the 2-stage stirring unit 200 is hinged to the vertically-moving bucket 10 through the shaft pin 61, and another end of the 2-stage stirring chamber 201 is locked to the 1-stage stirring chamber 101 through the latching plate 71. The 2-stage stirrer 202 can rotate 90 degrees around the shaft pin 61 in the direction B as shown in the figure by twisting off the latching plate 71, so it is convenient to install and maintain them.

As shown in FIG. 9, one end of the 2-stage stirring motor 203 is hinged to the 2-stage stirring chamber 201 through the second shaft pin 62, and another end of the 2-stage stirring motor 203 is locked to the 2-stage stirring chamber 201 through the second lock catch 52. The 2-stage stirring motor 203 can rotate around the second shaft pin 62 in the direction C as shown in the figure by unlocking the second lock catch 52.

FIGS. 13-16 show the second example of the vertically-moving bucket 10. As same as the first example, the 1-stage stirring unit 100 in this example includes the 1-stage stirring chamber 101 and the 1-stage stirrer 102 arranged in the 1-stage stirring chamber 101. The 2-stage stirring unit 200 includes the 2-stage stirring chamber 201 and the 2-stage stirrer 202 arranged in the 2-stage stirring chamber 201. The 3-stage stirring unit 300 includes the 3-stage stirring chamber 301 and the 3-stage stirrer 302 arranged in the 3-stage stirring chamber 301. The vertically-moving bucket 10, the 1-stage stirring chamber 101, the 2-stage stirring chamber 201, the pump chamber 401 and the 3-stage stirring chamber 301 communicate with the next in sequence.

In this example, the 1-stage stirring chamber 101, the 2-stage stirring chamber 201, the pump chamber 401 and the 3-stage stirring chamber 301 are arranged perpendicular to each other. The 1-stage stirring motor 103 is arranged outside the 1-stage stirring chamber 101. The output shaft of the 1-stage stirring motor 103, the 1-stage stirrer 102 inside the 1-stage stirring chamber 101, the 2-stage stirrer 202 inside the 2-stage stirring chamber 201, the rotor 402 inside the pump chamber 401 and the 3-stage stirrer 303 inside the 3-stage stirring chamber 301 are arranged coaxially, and connected to the next in sequence, that is, the output shaft of the 1-stage stirring motor 103 is connected to one end of the 1-stage stirrer 102 through the mortise-tenon connection 40, another end of the 1-stage stirrer 102 is connected to one end of the 2-stage stirrer 202 through the mortise-tenon connection 40, another end of the 2-stage stirrer 202 is connected to one end of the rotor 402 through the mortise-tenon connection 40, another end of the rotor 402 is the 3-stage stirrer 303 through the mortise-tenon connection.

As shown in FIG. 13, one end of the 1-stage stirring chamber 101 is connected with the vertically-moving bucket 10 by the third lock catch 53, while another end of the 1-stage stirring chamber 101 is connected with the 2-stage stirring chamber 201 by the fourth lock catch 53, and the 1-stage stirring chamber 101 can be quickly disconnected from the vertically-moving bucket 10 and the 2-stage stirring chamber 201 by removing the third lock catch 53 and the fourth lock catch 53.

As shown in FIG. 16, the 2-stage stirring chamber 201 is connected with the vertically-moving bucket 10 by the connecting rod 204, which can strengthen the rigidity of the entire structure.

Although the specific preferred examples are further described above in details, but it cannot be considered that the specific example of the invention is limited to such descriptions. Some simple deductions or substitutions possibly made by a person skilled in the art without departing from the conception to the invention should be regarded as pertaining to the protection scope of the invention.

1. A Z-axis integrated with storage, commixture and extrusion of materials, comprising:
a vertically-moving bucket, and
a vertically-moving unit connected to said vertically-moving bucket,
wherein said vertically-moving unit can drive said vertically-moving bucket to move vertically, said vertically-moving bucket is used to store printing materials, a printing nozzle connected to said vertically-moving bucket is provided at the bottom of said vertically-moving bucket, which is connected with said printing nozzle through a stirring unit mixing printing materials with water.

2. The Z-axis integrated with storage, commixture and extrusion of materials according to claim 1, wherein said vertically-moving bucket is provided with a controlling bucket, in which a preliminarily-stirring motor, a dust removal cloth bag and a material-level meter are arranged, a dry powder inlet is provided on said vertically-moving bucket, a preliminary stirrer connected to said preliminarily-stirring motor is provided inside said vertically-moving bucket, and can be driven by said preliminarily-stirring motor to rotate.

3. The Z-axis integrated with storage, commixture and extrusion of materials according to claim 1, wherein a rack is provided on the side of said vertically-moving bucket, said vertically-moving unit includes a gear meshing with said rack.

4. The Z-axis integrated with storage, commixture and extrusion of materials according to claim 1, wherein a screw stem is provided on the side of said vertically-moving bucket, said vertically-moving unit includes a nut meshing with said screw stem.

5. The Z-axis integrated with storage, commixture and extrusion of materials according to claim 1, wherein said Z-axis includes at least two stirring units, said at least two stirring units are connected between them through a screw pump.

6. The Z-axis integrated with storage, commixture and extrusion of materials according to claim 1, wherein a stirrer is provided inside said vertically-moving bucket.

7. The Z-axis integrated with storage, commixture and extrusion of materials according to claim 1, wherein said vertically-moving bucket is connected with said printing nozzle through three stirring units, which are a 1-stage stirring unit, a 2-stage stirring unit, and a 3-stage stirring unit, respectively, and each of which consists of one stirring chamber and the stirrer arranged inside the stirring chamber, and the stirring chambers of the three stirring units are connected to the next in sequence, and the stirring chamber inside said 3-stage stirring unit communicates with said printing nozzle.

8. The Z-axis integrated with storage, commixture and extrusion of materials according to claim 7, wherein the stirring chamber of said 1-stage stirring unit communicates with the bottom of said vertically-moving bucket, one end of the stirrer of said 1-stage stirring unit is positioned inside the stirring chamber of said 1-stage stirring unit, while another end is positioned at the bottom of said vertically-moving bucket, a water inlet is provided on said 1-stage stirring unit, which mixes dry mortar in said vertically-moving bucket with water into wet-mixed mortar, and then the wet-mixed mortar passes through said 2-stage stirring unit and said 3-stage stirring unit in sequence, and is finally extruded from said printing nozzle.

9. The Z-axis integrated with storage, commixture and extrusion of materials according to claim 7, wherein a second material-level meter is arranged inside said 2-stage stirring unit, said second material-level meter has the ability to turn off said 1-stage stirring unit.

10. The Z-axis integrated with storage, commixture and extrusion of materials according to claim 7, wherein the stirrer of said 3-stage stirring unit includes two cross-shaped stirring members arranged coaxially, the two stirring members include 4 stirring blades, respectively, and the stirring blades of the two stirring members are staggered in the axial direction.

11. The Z-axis integrated with storage, commixture and extrusion of materials according to claim 7, wherein said 1-stage stirring unit includes a 1-stage stirring chamber and a 1-stage stirrer arranged in said 1-stage stirring chamber, said 2-stage stirring unit includes a 2-stage stirring chamber and a 2-stage stirrer arranged in said 2-stage stirring chamber, said 3-stage stirring unit includes a 3-stage stirring chamber and a 3-stage stirrer arranged in said 3-stage stirring chamber, said 2-stage stirring unit is connected with said 3-stage stirring unit by a screw pump, which includes a pump chamber and said rotor arranged inside said pump chamber, said vertically-moving bucket, said 1-stage stirring chamber, said 2-stage stirring chamber, said pump chamber and said 3-stage stirring chamber communicate with the next in sequence.

12. The Z-axis integrated with storage, commixture and extrusion of materials according to claim 11, wherein said 1-stage stirring chamber and said 2-stage stirring chamber are perpendicularly arranged, said 2-stage stirring chamber, said pump chamber and said 3-stage stirring chamber are parallelly arranged, a 2-stage stirring motor is arranged outside said 2-stage stirring chamber, the output shaft of said 2-stage stirring motor, the 2-stage stirrer inside said 2-stage stirring chamber, the rotor inside said pump chamber and the 3-stage stirrer inside said 3-stage stirring chamber are arranged coaxially.

13. The Z-axis integrated with storage, commixture and extrusion of materials according to claim 11, wherein said 1-stage stirring chamber, said 2-stage stirring chamber, said pump chamber and said 3-stage stirring chamber are parallelly arranged, a 1-stage stirring motor is arranged outside said 1-stage stirring chamber, the output shaft of said 1-stage stirring motor, the 1-stage stirrer inside said 1-stage stirring chamber, the 2-stage stirrer inside said 2-stage stirring chamber, the rotor inside said pump chamber and the 3-stage stirrer inside said 3-stage stirring chamber are arranged coaxially.

14. A 3D building printer, comprising a horizontal movement platform and said Z-axis integrated with storage, commixture and extrusion of materials according to claim 1 provided on said horizontal movement platform.

15. The 3D building printer according to claim 14, wherein a guiding rail is arranged on the side of said vertically-moving bucket, said horizontal movement platform is provided with a sliding block slidably coordinating with said guiding rail, which is limited by said sliding block to move in the vertical direction after passing through said sliding block.

16. The 3D building printer according to claim 14, wherein said horizontal movement platform includes two spaced crossbeams, between which an avoidance space for avoiding said vertically-moving bucket is formed, said horizontal movement platform includes a Y-axis movement platform movably arranged on the two crossbeams, and a Y-axis movement mechanism used to drive said Y-axis movement platform to move, said Y-axis movement platform is provided with an avoidance channel corresponding to said avoidance space, said vertically-moving bucket can pass through the avoidance channel.

17. The 3D building printer according to claim 16, wherein said Y-axis movement platform is provided with a guiding roller and a limiting roller, said limiting roller is connected to said Y-axis movement platform through a suspension support, said guiding roller and said limiting roller match with the upper and lower sides of said crossbeam.
